(19) United States
(12) Patent Application Publication
(10) Pub. No.: US 2010/0119119 A1
(43) Pub. Date: May 13, 2010

(54) AUTOMATED SYSTEMS AND METHODS FOR SCREENING ZEBRAFISH

(75) Inventors: Jens Rittscher, Ballston Lake, NY (US); Ahmad Yekta, Somerset, NJ (US); Musodiq O. Bello, Niskayuna, NY (US); Jilin Tu, Schenectady, NY (US); Wen Lin Seng, Westborough, MA (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/403,587

(22) Filed: Mar. 13, 2009

Related U.S. Application Data
(63) Continuation-in-part of application No. 12/267,019, filed on Nov. 7, 2008.

(51) Int. Cl. G06K 9/00

(52) U.S. Cl. 382/110

(57) ABSTRACT

Systems and methods for screening zebrafish comprising, a storage device for at least temporarily storing an image of a zebrafish to be screened; a zebrafish atlas; and an operating device that automatically screens the zebrafish at least in part by automatically comparing one or more anatomical features of the zebrafish to one or more standards.

### CROSS REFERENCE TO RELATED APPLICATIONS

This application is a continuation-in-part of U.S. patent application Ser. No. 12/267,019 entitled “SYSTEMS AND METHODS FOR AUTOMATED EXTRACTION OF HIGH-CONTENT INFORMATION FROM WHOLE ORGANISMS”, filed Nov. 7, 2008, which is hereby incorporated by reference.

### BACKGROUND

The invention relates generally to automated systems and methods for screening zebrafish.

Zebrafish is a well-known vertebrate model for developmental biology, molecular genetics, and toxicology studies. Zebrafish offer many advantages over other research models such as mice including the small size of zebrafish, low husbandry costs, ex utero transparent embryos, early morphology distinction, large number of embryos produced per mating, and the similarity of its genome to that of humans. Zebrafish are commonly used to study the toxicological effect of various drugs on cell apoptosis, organ development (e.g. brain, liver, tail, ear) as well as cardiac and nervous system functions, such as specific teratogenicity assays. Generally teratogenicity screens should be able to process large number of samples, provide progressive development, relate to teratogenicity mechanisms, and easy to run and interpret. T. J. Haley W. O. Brendt; Toxicology; (1987), p. 265.

Research using zebrafish as a model organism has extended to modeling human diseases and analyzing the formation and functions of cell populations in organs within the organism. This work has generated new human disease models and has begun to identify potential therapeutics, including genes that modify disease states and chemicals that rescue organs from disease.

The recent development of the zebrafish as a model for chemical genetics has established chemical screening in vivo as an adjunct to older screening technologies in cell lines or in vitro. Soluble chemicals permeate into zebrafish embryos and produce specific effects. In contrast to screening by in vitro techniques, zebrafish offers an in vivo vertebrate model for studying the bioactivity of chemicals. In addition, the availability of large numbers of zebrafish mutants makes chemical suppressor screens fast and straightforward. The targets of chemicals found to prevent or cure disease phenotypes in zebrafish will, in general, have very close cognates in humans. Therefore these screens promise to provide key entry points for the development of new therapeutic drugs.

In contrast to other vertebrate models, zebrafish complete embryogenesis in the first 72 hours post fertilization. Most of the internal organs, including the cardiovascular system, gut, liver and kidney, develop rapidly in the first 24 to 48 hour. Zebrafish embryos are also transparent, which facilitates observation and analysis. All the precursor tissues of the brain, eyes, heart and musculature can be easily visualized using light microscopy. Another important advantage of this animal model is that the morphological and molecular basis of tissue and organ development is, in general, either identical or similar to other vertebrates, including humans. Since single embryos can be maintained in fluid volumes as small as 100 μl for the first five to six days of development, they can be kept in individual microtiter wells. Reagents can then be added directly to the solution in which the embryos develop, simplifying drug dispensing and facilitating analysis. Zebrafish embryos, which are permeable to small molecules, provide easy access for drug administration and vital dye staining. Small molecules, including peptides, dyes and drugs can be simply dissolved in fish water and taken up by the zebrafish in the absence or presence of a carrier (e.g., 0.1% dimethyl sulfoxide, DMSO). Compound treatment can be performed in 96- or 384-well microwells using conventional liquid handling and quantitative ELISA formats. Use of zebrafish as an alternative animal model for drug screening can greatly accelerate the drug screening process, decrease costs, and provide more accurate results than cell-based assays. Use of zebrafish as an alternative animal model for mammals (e.g., rodents, primates, etc.) in preclinical drug screening can greatly accelerate the discovery process, decrease costs, and allow higher throughput than traditional animal studies. Use in drug and environmental toxicology can increase throughput and alleviate some of the animal rights concerns.

However, such studies rely on various measurements such as, but not limited to, liver size, tail length and curvature, size and frequency of spots, and the presence or absence of axons. At present, these measurements are typically obtained manually, or using generic imaging software and manual tracing of image features. Such methods are time consuming and inefficient given the small size of these research models and subject to human bias.

Currently, automated, high-content, medium- or high-throughput systems and methods do not exist for measuring and quantifying the effects of compounds on zebrafish and zebrafish development.

### BRIEF DESCRIPTION

The systems and methods of one or more of the embodiments facilitate toxicology studies in zebrafish, by providing high-content, medium-throughput, automated systems and methods for screening zebrafish for evidence of toxicity. These systems and methods enable in vivo assessment of compounds and environmental chemicals and their side effects in zebrafish over time and across different doses. When used in high-content, automated systems, the systems and methods enable rapid, automated and extensive compound screening such as the screening of compound libraries.

An embodiment of the system of the invention for screening zebrafish generally comprises: a storage device for at least temporarily storing an image of a zebrafish to be screened; a zebrafish atlas; and an operating device that automatically screens the zebrafish at least in part by automatically comparing one or more anatomical features of the zebrafish, determined in part using the zebrafish atlas, to one or more standards; wherein one or more of the anatomical features of the zebrafish may comprise measurements of the zebrafish, body, notochord, tail, trunk, pericardial edema region, eye, head, abdomen, swim bladder, jaw, heart chamber, gastrointestinal tract, or liver. The anatomical features of the zebrafish comprise spots, brain color, brain texture, tail shape, somite shape, eye pigmentation, body pigmentation, straightness of the notochord, fin shape, intestine shape, intestine color, existence of axons, or cell or tissue necrosis. The atlas of the system may also be is automatically adaptable. The standards may comprise, but are not limited to, a control fish, a previous image of the zebrafish, a library-based standard, or an amalgamation of a plurality of fish.

The operating device may also identify a strain to which the zebrafish corresponds, wherein the strain may be identified at least in part by comparing the zebrafish to a library of candidate zebrafish strains accessible to the operating system, or by comparing one or more of the anatomical features to one or more of the candidate zebrafish strains in the library. The anatomical features may comprise one or more measurements of the zebrafish, wherein the operating device screens the zebrafish for toxicity at least in part by comparing one or more of the measurements to a toxicity standard. The measurements may comprise one or more of length, area, curvature, color, texture, shape, intensity and combinations thereof. The operating device may screen the zebrafish at least in part by automatically identifying one or more developmental defects in the zebrafish.

The system may also further comprise an imaging device to create one or more images of the zebrafish to be screened. The imaging device may be used, for example, to take a plurality of images of the zebrafish at various levels of resolution, wherein one of the images may be a lower resolution image of the entire zebrafish and one of the images is a higher resolution image of one or more organs within the zebrafish. The operating system may be configured to apply real-time atlas analysis to one or more low-resolution images, to initiate acquisition of one or more high-resolution images, at least in part by identifying the organ and centering the organ in a high magnification field of view. The imaging device may also take a plurality of images at various levels of resolution automatically, based at least in part, on the comparison of the image of the zebrafish to the zebrafish atlas.

The storage device may also store information on one or more agents, and wherein the operating device gathers data relating to one or more organs within the zebrafish and correlates the data with the information on one or more agents, wherein the operating device may determine one or more levels of toxicity based on the correlation of the organ data to the agent information.

An example of the method of the invention for screening zebrafish generally comprises: providing an image of a zebrafish to be screened; providing a zebrafish atlas and automatically measuring one or more anatomical features of the zebrafish at least in part using the atlas; and screening the zebrafish at least in part by automatically comparing one or more of the anatomical features of the zebrafish to one or more standards. The measurements and standards may comprise one or more of length, area, curvature, color, texture, shape, intensity and combinations thereof. The method may further comprise automatically determining a developmental stage of the zebrafish, such as, broad embryo, larval and adult stages, and more specific sub-stages.

The anatomical features of the zebrafish may comprise the zebrafish body, notochord, tail, trunk, pericardial edema region, eye, head, abdomen, swim bladder, jaw, heart chamber, gastrointestinal tract, or liver. The anatomical features of the zebrafish may also comprise spots, brain color, brain texture, tail shape, somite shape, eye pigmentation, body pigmentation, straightness of the notochord, fin shape, intestine shape, intestine color, existence of axons, or cell or tissue necrosis.

The standards may comprise, but are not limited to, a control fish, a previous image of the zebrafish, a library-based standard, or an amalgamation of a plurality of fish, wherein the amalgamation may comprises a computed statistic of one or more features of the plurality of fish that correspond to the anatomical features of the zebrafish.

The method may further comprise identifying a strain to which the zebrafish corresponds wherein the strain is identified at least in part by automatically comparing the zebrafish to a library of candidate zebrafish strains accessible to the operating system. The method may also determine a phenotype or genotype of the zebrafish.

If the zebrafish is being screened for toxicity, the toxicity may be screened at least in part by automatically identifying one or more developmental defects in the zebrafish. The method may also comprise determining one or more levels of toxicity in one or more organs of the zebrafish.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram of an embodiment of an atlas useful in one or more of the systems and methods of the invention.

FIG. 2 is a diagram of an embodiment of subdivision levels of the atlas shown in FIG. 1.

FIG. 3 show four 120-hour zebrafish samples, three of which have been treated, each with a different compound, and a fourth that serves as a control.

FIG. 4 illustrates an example of developmental deformities that are indicative of toxicity showing control zebrafish and treated zebrafish exhibiting deformed head and curvature in the tail.

FIG. 5 illustrates an example of cell death that is indicative of neurotoxicity showing a control zebrafish with clearly formed eyes and a treated zebrafish showing drug-modulated apoptosis in the eye area and brain.

FIG. 6 illustrates another example of developmental deformities that are indicative of toxicity showing control zebrafish and treated zebrafish exhibiting deformed head and curvature in the tail.

FIG. 7 is an embodiment of a magnification of a sub-region of an organism of interest.

FIG. 8 is an illustration of an embodiment of a set of measurement endpoints of a zebrafish.

FIG. 9 is a flow diagram of an embodiment of an atlas-based measurement process useful in one or more of the systems and methods of the invention.

FIG. 10 is an example of a comparison of an automatically fitted atlas (solid lines) to a manually fitted atlas (dotted lines).

FIG. 11 is a matrix plot of an example of measurements of a set of sample zebrafish.

FIG. 12 is an example of a comparison of body length measurements in normal 120-hour zebrafish.

FIG. 13 comprises flow diagrams of embodiments of methods and systems for A) determining anatomically relevant measurements, B) identifying organs, and C) training an atlas for specific populations.

FIG. 14 is a diagram of an embodiment of an automated system of the invention.

### DETAILED DESCRIPTION

The systems and methods of one or more of the embodiments enable medium-throughput, automated screening of toxicity in zebrafish, and in some more specific embodiments, the type and extent of toxicity may be determined. The systems and methods can readily make use of libraries of zebrafish phenotypes and genotypes, as well as libraries relating to agents, biomarkers and probes.

One or more of the embodiments may also be configured to generate scores based on a combination of measurements and/or other information relevant to research. For example, for a given assay, a set of morphological and textural descriptors may be extracted from each fish being screened, as well as for specific organs and subparts of organs within the fish. In one or more of the embodiments of the systems and methods, an atlas of a zebrafish is used as the standard or model to which the zebrafish, being screened, is compared. Such shape and appearance descriptors are stored, in some of the embodiments of the systems, as metadata, or are otherwise accessible to the system's operating subsystem. In one or more example embodiments, a query regarding a particular fish will result in various scores for individual toxicology endpoints. In one or more example embodiments, a query regarding a particular toxicology endpoint will produce the fish that have high scores for specific features relating to that endpoint.

One or more of the embodiments of the methods and systems are adapted for toxicology screening, by which toxicity is quantitatively assessed on a continuous scale and phenotypes are objectively identified based, as a nonlimiting example, on their morphometric or relative intensity features.

To more clearly and concisely describe and point out the subject matter of the claimed invention, the following definitions are provided for specific terms, which are used in the following description and the appended claims. Throughout the specification, exemplification of specific terms should be considered as non-limiting examples.

As used herein, the term “atlas” refers to a digitized graphical representation of an organism's anatomy ontology. The atlas may be a graphical representation of the entire organism or may be divisible into portions or regions of the organism. The atlas may be a representation of various types or versions of an organism including, but not limited to, normal, wild-type, mutant, transgenic, agent-treated, probe-treated, genetically engineered, modified, or artificially created, organisms. The representation may be from a single organism or may be synthesized, or otherwise computed or artificially created (e.g. averaged), from a group or groups of organisms. The atlas may comprise one or more of a representation of an organism on which the spatial extent and coordinates of the representation is defined; an ontology of terms; and a mapping, or interpretation, between the representation and the ontology. The ontology may comprise the structural changes that occur during development of the organism (e.g. embryonic development stages) and may further comprise one or more hierarchies, for each development stage, wherein a stage may be characterized by internal and external morphological features of the organism.

As used herein, the term “annotation” refers to words, symbols, letters, images, numbers, marks and phrases that may be added, deleted, amended, or replaced. Annotations may be entered by the system based on preset guidelines or rules or by system-adaptable guidelines or rules, or by a user of the system. The annotations may be entered manually, automatically, or electronically using a keyboard, a stylus, touchpad, or using verbal identification software. The means of entry may be wired or wireless. Annotations may be, but are not limited to, semantic, textual, explanatory, commentary, illustrative, automated, pictorial, auditory, or linguistic in nature. Annotations may be visible to the viewer on-screen, embedded, hypertext, archived or retrievable, without limitation.

As used herein, the term “agent” refers to any element, compound, compound cocktail or entity including, but not limited to, e.g. pharmaceutical, therapeutic, pharmacologic, environmental or agricultural pollutant or compound, toxin, aquatic pollutant, cosmeceutical, drug, toxin, natural product, synthetic compound, or chemical compound.

As used herein, the terms “biomarker” and “channel marker” include, but are not limited to, fluorescent imaging agents and fluorophores that are chemical compounds, which when excited by exposure to a particular wavelength of light, emit light at a different wavelength. Fluorophores may be described in terms of their emission profile, or “color.” Green fluorophores (for example Cy3, FITC, and Oregon Green) may be characterized by their emission at wavelengths generally in the range of 515-540 nanometers. Red fluorophores (for example Texas Red, Cy5, and tetramethylrhodamine) may be characterized by their emission at wavelengths generally in the range of 590-690 nanometers. An examples of an orange fluorophore is a derivative of 1,5-bis{[2-(di-methylamino) ethyl]amino}-4, 8-dihydroxyanthracene-9,10-dione (CyTRAK Orange™) that stains both nucleus and cytoplasm, and examples of far-red fluorophores are 1,5-bis{[2-(di-methylamino) ethyl]amino}-4,8-dihydroxyanthracene-9,10-dione (DRAQ5™) a fluorescent DNA dye and 1,5-bis({[2-(di-methylamino) ethyl]amino}-4,8-dihydroxyanthracene-9,10-dione)-N-Oxide (APOPTRAK™) a cellular probe. Examples of fluorophores include, but are not limited to, 4-acetamido-4′-isothiocyanatostilbene-2,2′disulfonic acid, acridine, derivatives of acridine and acridine isothiocyanate, 5-(2′-aminoethyl)aminonaphthalene-1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide, anthranilamide, Brilliant Yellow, coumarin, coumarin derivatives, 7-amino-4-methylcoumarin (AMC, Coumarin 120), 7-amino-trifluoromethylcouluarin (Coumaran 151), cyanosine; 4′,6-diaminidino-2-phenylindole (DAPI), 5′,5″-dibromopyrogallol-sulfonephthalein (Bromopyrogallol Red), 7-diethylamino-3-(4′-isothiocyanatophenyl)-4-methylcoumarin, -, 4,4′-diisothiocyanatodihydro-stilbene-2,2′-disulfonic acid, 4,4′-diisothiocyanatostilbene-2,2′-disulfonic acid, 5-[dimethylamino]naphthalene-1-sulfonyl chloride (DNS, dansyl chloride), eosin, derivatives of eosin such as eosin isothiocyanate, erythrosine, derivatives of erythrosine such as erythrosine B and erythrosin isothiocyanate; ethidium; fluorescein and derivatives such as 5-carboxyfluorescein (FAM), 5-(4,6-dichlorotriazin-2-yl) aminofluorescein (DTAF), 2′7′-dimethoxy-4′5′-dichloro-6-carboxyfluorescein (JOE), fluorescein, fluorescein isothiocyanate (FITC), QFITC (XRITC); fluorescamine derivative (fluorescent upon reaction with amines); IR144; IR1446; Malachite Green isothiocyanate; 4-methylumbelliferone; ortho cresolphthalein; nitrotyrosine; pararosaniline; Phenol Red, B-phycoerythrin; o-phthaldialdehyde derivative (fluorescent upon reaction with amines); pyrene and derivatives such as pyrene, pyrene butyrate and succinimidyl 1-pyrene butyrate; Reactive Red 4 (Cibacron™ Brilliant Red 3B-A), rhodamine and derivatives such as 6-carboxy-X-rhodamine (ROX), 6-carboxyrhodamine (R6G), lissamine rhodamine B sulfonyl chloride, rhodamine (Rhod), rhodamine B, rhodamine 123, rhodamine X isothiocyanate, sulforhodamine B, sulforhodamine 101 and sulfonyl chloride derivative of sulforhodamine 101 (Texas Red); N,N,N′,N′-tetramethyl-6-carboxyrhodamine (TAMRA); tetramethyl Rhodamine, tetramethyl rhodamine isothiocyanate (TRITC); riboflavin; rosolic acid and lathanide chelate derivatives, quantum dots, cyanines, pyrelium dyes, and squaraines.

As used herein, the term “developmental defect” refers to deficiency, imperfection, or difference in the development of a tissue, organ, or other bodily component of an organism relative to normal development. Such a defect may be identified as a change, difference, or lack of something necessary or desirable for completion or proper operation in the development of a tissue, organ, or other bodily component of an organism.

As used herein, the term “organ” refers to a group of tissues that perform a specific function or group of functions (e.g. heart, lungs, brain, eye, stomach, spleen, bones, pancreas, kidneys, liver, intestines, skin, urinary bladder and sex organs).

As used herein, the term “probe” refers to an agent having a binder and a label, such as a signal generator or an enzyme. In some embodiments, the binder and the label (signal generator or the enzyme) are embodied in a single entity. The binder and the label may be attached directly (e.g., via a fluorescent molecule incorporated into the binder) or indirectly (e.g., through a linker, which may include a cleavage site) and applied to the biological sample in a single step. In alternative embodiments, the binder and the label are embodied in discrete entities (e.g., a primary antibody capable of binding a target and an enzyme or a signal generator-labeled secondary antibody capable of binding the primary antibody). When the binder and the label (signal generator or the enzyme) are separate entities they may be applied to a biological sample in a single step or multiple steps. As used herein, the term “fluorescent probe” refers to an agent having a binder coupled to a fluorescent signal generator.

As used herein, the term “toxin” refers to any substance that has the potential to cause harm to the organism.

As used herein, the term “standard” includes, but is not limited to, any information that serves as a baseline for comparison. For example, a standard may comprise, but is not limited to, one or more real or artificially created or defined parameters or points (e.g. length, area, curvature, color, texture, shape, intensity, combinations thereof), a control fish, a previous image of the zebrafish (e.g. taken prior to application of an agent or probe), a predetermined standard (e.g. stored library of standards, expert-based standard), a baseline created in real-time with the analysis (e.g. automatically by the system or manually by a user), defined by a subpopulation (e.g. manually or automatically), a control run, a longitudinal study-based standard (e.g. based on a fixed time point of a single or population), or an amalgamation of a plurality of fish. An amalgamation may comprise a computed statistic of one or more features, for example, of the plurality of fish or a plurality of images of the one or more fish, which correspond to the anatomical features of interest of the zebrafish being screened.

The example methods and systems automate the analysis of zebrafish for various research and screening studies such as toxicology studies. Measurements of the fish, such as, but not limited to, the length of the fish, number of spots on the head and tail, curvature of the tail, and liver shrinkage are carried out automatically using various shape descriptors based on models of the fish. These measurements can then be used, for example, to compute various drug-related indicators such as dose response, half maximal effective concentration (EC50), and half maximal inhibitory concentration (IC50). Images may be acquired by various modalities as in transmitted light and fluorescence imaging, each in various spectral bands, or in combination constituting hyperspectral imaging. The shape descriptors may be stored in a database in a memory device in the system or otherwise accessible to the system via a removable memory device or through a server. These shape descriptors facilitate the search and comparison of fish phenotypes to the organism of interest being screened. Furthermore, such databases can be integrated with other zebrafish databases (e.g., gene databases on ZFIN). The extraction of shape and appearance features at the organ level mimics the current approach of toxicologists. However, the database may also serve as a discovery tool in which several features can be combined to qualify a phenotype. It is to be understood that correlation and clustering patterns of several phenotypes may constitute emergent signs of toxicity not easily detected by human visual inspection, on small organisms or the higher mammals.

One aspect of the methods and systems is to enable detection and identification of the development stage of a zebrafish. Depending on the organism of interest, the developmental stage of a given zebrafish is important when detecting and identifying the anatomy of the zebrafish. At least one of the example embodiments of the methods and systems detects the developmental stage of the zebrafish automatically. Another aspect of the methods and systems is to enable detection and identification of the viability of the zebrafish for the initial screening before the start of compound treatment studies (dead vs. alive).

For example, zebrafish are transparent during their embryonic stage. For various applications the developmental stages of the zebrafish are important, nonlimiting examples of which are listed below:

6 hours: at six hours, as a measure of quality control, it is possible to detect whether fertilization is successful;
48 hours: at forty-eight hours it is possible to determine whether the heart function and morphology deviate from the norm;
96 hours: at ninety-six hours it is possible to determine whether gastrointestinal toxicity has occurred, also swim bladder can be analyzed;
120 hours: at one hundred twenty hours it is possible to test for liver toxicity.

Anatomical features that are relevant to toxicity in zebrafish include, but are not limited to, the overall zebrafish body, notochord, tail, trunk, pericardial edema, eye, head, abdomen, swim bladder, jaw, heart chamber, gastro-intestinal tract, and liver. The anatomical features of the zebrafish may also comprise general spots, brain color, brain texture, tail shape, somite shape, eye pigmentation, body pigmentation, cardiac change (e.g. over time), straightness of the notochord, fin shape, intestine shape, intestine color, existence of axons, or cell or tissue necrosis.

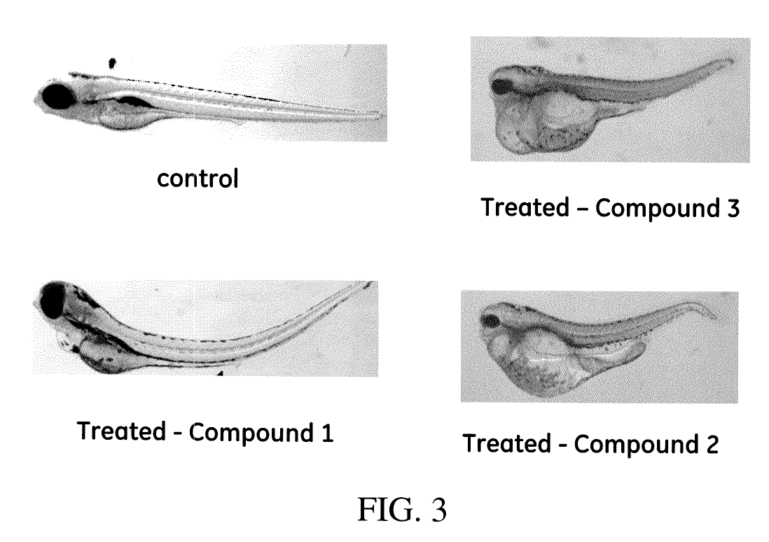

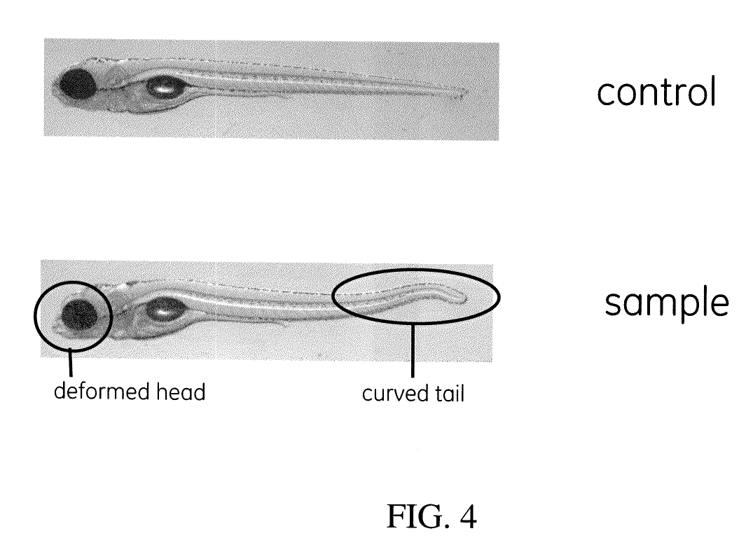

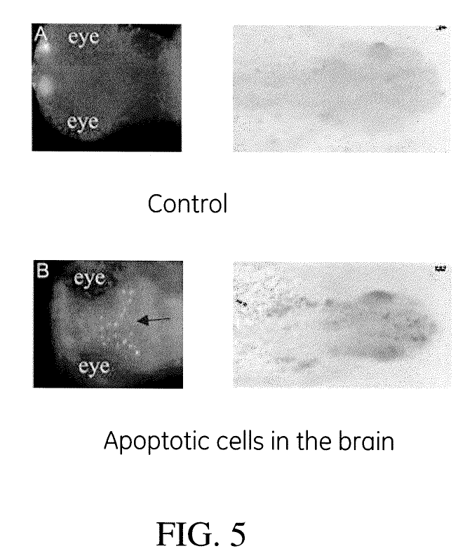

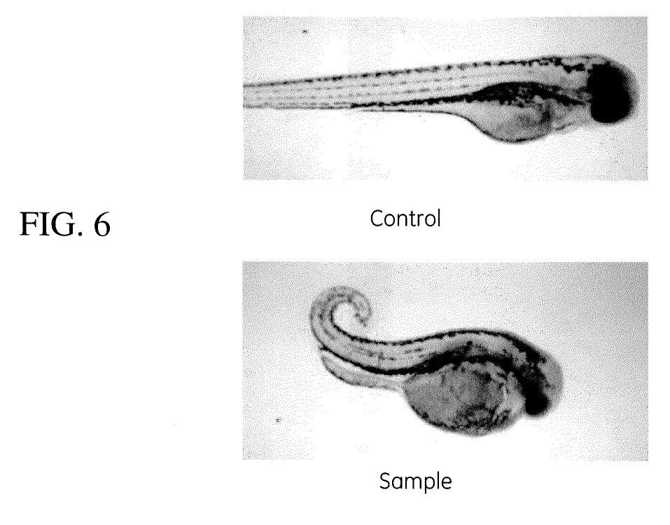

For example, FIG. 3 shows four 120-hour zebrafish samples, three of which have been treated, each with a different compound, and a fourth that serves as a control. FIGS. 4 and 6 illustrate developmental deformities that are indicative of toxicity showing control zebrafish and treated zebrafish exhibiting deformed heads and curvatures in the tail. FIG. 5 illustrates cell death that is indicative of neurotoxicity showing a control zebrafish with clearly formed eyes and a treated zebrafish showing drug-modulated apoptosis in the eye area and brain.

Evaluation protocols are formulated for a given developmental stage of the organism. For example, below is an example protocol for evaluating a 5-day old zebrafish (120 hours):

Heart morphology: Assessment of overall heart morphology and function. The physical structure of the heart can be investigated. Flow asynchronies may also be monitored. Various morphological features can be measured such as pericardial edema length, to determine and detect abnormalities, and cardiac changes over time.
Trunk/swim bladder: Screening for edema in the region of the head.
Hemorrhage: Detect areas of accumulated blood. These areas will appear as dark red spots on the fish.
Brain morphology: Using both axial and sagittal views of the fish, changes in brain morphology can be used to determine and detect abnormalities.
Brain Tissue Toxicity effects on the brain can be determined using the color and texture of the brain. For example, brain tissue becomes opaque and the overall intensity of the image will be considerably darker.
Jaw morphology: Subtle changes in the head morphology may indicate that the jaw development has been affected.
Tail morphology: Changes in the shape of the tail, such as curvature and kinks (FIG. 4) in the tail, may indicate developmental defects. Also, the somites, which are parallel lines on the tail of the fish may be disrupted.
Eye pigmentation: Regions of the eye that are no longer black indicate that pigment cells no longer exist and the eye will become transparent.
Body pigmentation: Changes in the overall number of black spots on the surface of the fish may indicate developmental defects.
Notochord morphology: The notochord of a normal fish is delineated by two virtually parallel lines. When these lines become wavy or other wise are not straight, this may indicate developmental defects.
Fin morphology: Using an axial or dorsal view, when the fins on the side of the fish are malformed or have not developed, this may indicate a developmental defect.
Liver tissue: Changes in the color and texture of the liver may be indicative of defects. For example, the color of the liver may turn brown and the tissue may appear not to have any surface texture.
Intestine morphology: Malformation of the gastrointestinal tract may be indicative of defects.
Intestine tissue: The tissue of a normal GI tract is slightly yellow and it is possible to visualize folds in the intestine. Changes in color and the folds in the intestine may be indicative of defects.

Another feature of some of the embodiments of the methods and systems is automated image analysis. Automated image analysis enables process standardization that is very important for screening the effects of drugs and toxins on zebrafish and their organ development. For example, automated image analysis of zebrafish enables repetitive tasks, detect rare events, quantify the extent of different stains, classify and count numerous features, and answer questions that are beyond the capabilities of manual microscopy. In the context of modeling, it is essential to have quantified data of the biological and image-based experiments. High-throughput image analysis is the most practical way to accomplish such a task.

Another feature of one or more of the embodiments is to detect and identify the anatomical structures of the organism in part by comparing a zebrafish to be screened with a digital zebrafish atlas. At least one embodiment of the methods and systems may be configured to detect and identify the various developmental stages of the organism. Although the atlas may be constructed in various ways, at least one embodiment of the atlas is constructed using a 2-dimensional deformable mesh. A given set of measurements may be defined using the vertices of the mesh.

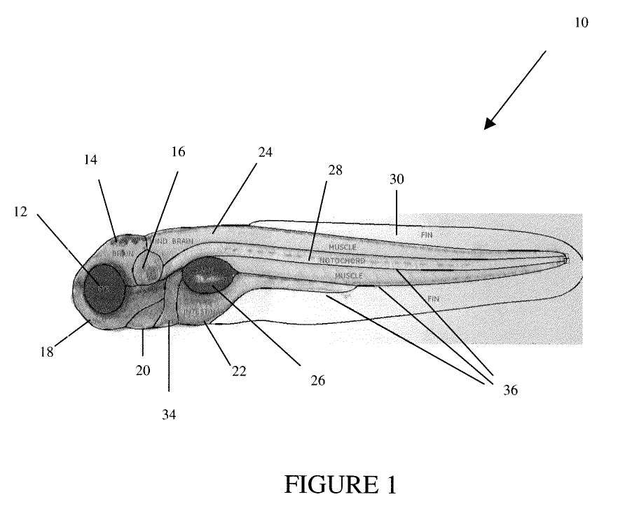

The atlas for a given organism should capture all the relevant regions of the organism. A non-limiting example of such an atlas is shown in FIG. 1 for a zebrafish that is approximately 5-days-old (120 hours). The atlas 10 comprises twelve anatomical regions. In this example, the regions shown are the eye 12, mid brain 14, ear 16, jaw 18, liver 20, intestine 22, hindbrain 24, bladder 26, notochord 28, muscle 30, fin 32, and heart 34. In this example, subdivision surfaces 36 are incorporated to model the shape and regions of the individual fish at multiple resolutions. The methods may also be used to construct an atlas in three dimensions (3D). Both the atlas generation and the automatic atlas registration do not depend on the dimensionality of the data. For example, an atlas may be three dimensional (3D) whereby the image of the fish is acquired as a set of Z-stack images taken orthogonal to the sagittal or axial direction, or two images in stereo or two images in two different axes. An atlas may also incorporate a time component (2D+time or 3D+time) in which the image is taken repeatedly over time (e.g. to measure cardiac rate.

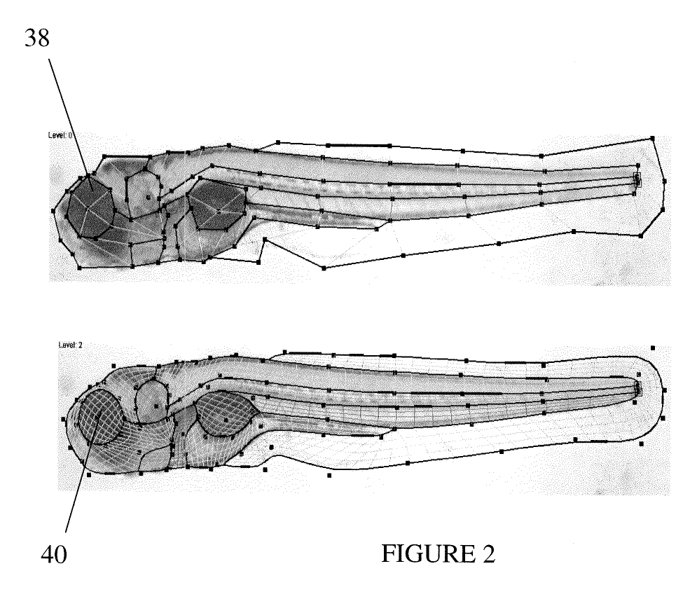

FIG. 2 is an example of an atlas showing two levels of mesh subdivisions. The first level subdivides each region into large sub-regions 38 and the second level subdivides each region into smaller sub-regions 40. The variety in size, shape and purpose of the subdivisions may be adapted for a given application. Although these example atlases comprise all the major anatomical features of a zebrafish, these examples are not limiting. The atlas may be refined and adapted by the user as needed for a given organism. For example, a user may annotate a certain sub-region of the atlas as a region of interest.

Atlases may also be created for a variety of uses such as phenotyping studies. For example, atlases may be created for a sub-population such as a mutant strain or for subpopulations used in knock-out studies.

In one or more of the embodiments of the methods and systems, an automatic fitting algorithm is used to register or otherwise match or compare the atlas to the example of the individual fish. Once registered, the system may be configured to carry out a variety of measurements and analyze the sample fish being tested. The type of measurements and analysis can be automatically generated by the system based on, for example, the type of organism, assay or test. The user may also make selections or enter customized instructions into the system as needed.

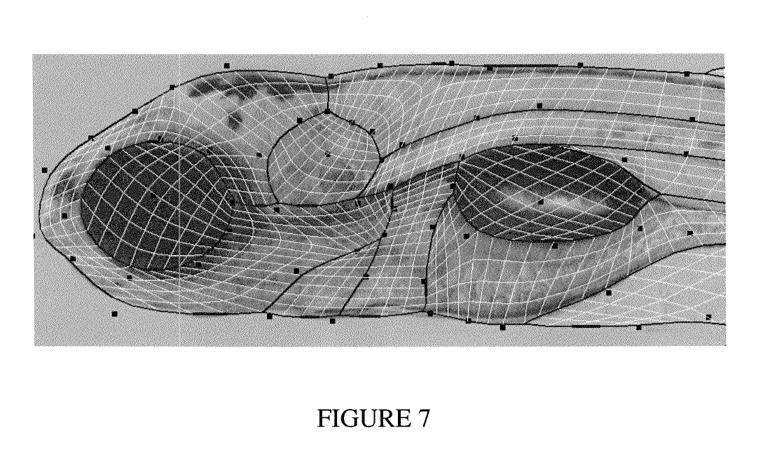

As shown in FIG. 7, the regions and sub-regions of the organism being tested may be automatically or selectively, enlarged, enhanced or otherwise analyzed, by the system or user. For example, if an assay or toxicity test is directed at the effect on the liver, the system could automatically identify the liver region and then automatically enlarge or otherwise digitally or optically enhance and/or analyze the liver region. If a sub-region is subsequently identified as a sub-region of interest within the liver region, then the system could further enlarge, enhance and/or analyze the sub-region of interest. The image of the organism that is the subject of a given assay or test could be automatically or manually annotated by the system or user to mark, for example, a sub-region showing an anomaly.

As another example, if a given assay requires the measurement of the uptake of a fluorescent marker in a region of the zebrafish notochord, a user could mark the region as a region of interest in the atlas. The system could then measure and/or analyze the region of interest and generate a report or analysis of one or more features or characteristics of the region or sub-region.

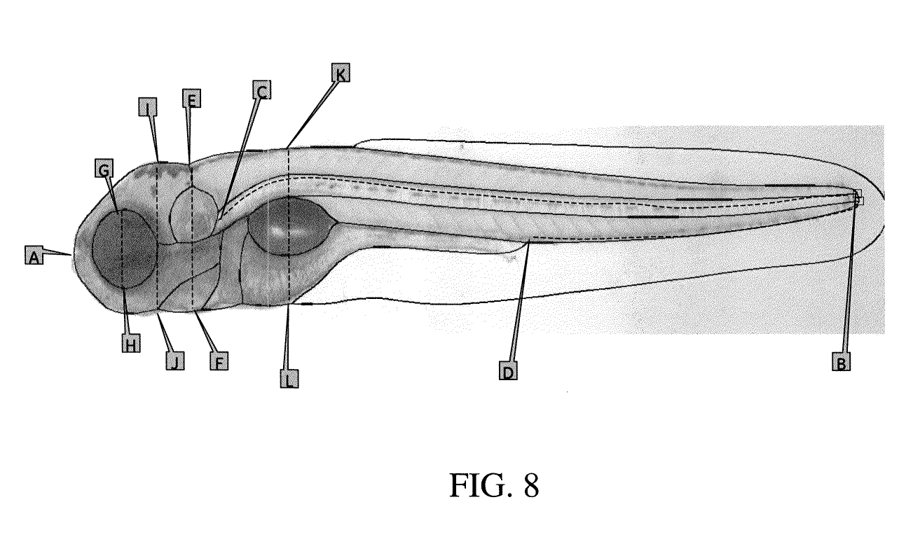

A feature of one or more of the embodiments, when using an atlas, is the ability of the system to automatically carry out anatomically relevant measurements as defined by the structure of the atlas. Once the atlas is registered to a particular fish sample, any or all of the measurements can be computed automatically. An example of a possible set of area and length measurements is shown in FIG. 8 for a 5 day old zebrafish. In this example, the length measurements are based at least in part on the dotted lines on the fitted map. The area measurements are based at least in part on the solid lines on the fitted amp. For illustration only, area and length measurements, as shown in FIG. 8, for a zebrafish may comprise the following:

### Length Measurements

AB body length
BC notochord length
BD tail length
AD trunk length
EF pericardial edema length
GH eye size
IJ head width
KL abdominal width

### Area Measurements

### Eye

Swim bladder

### Jaw

Heart chamber
Gastro-intestinal tract

### Liver

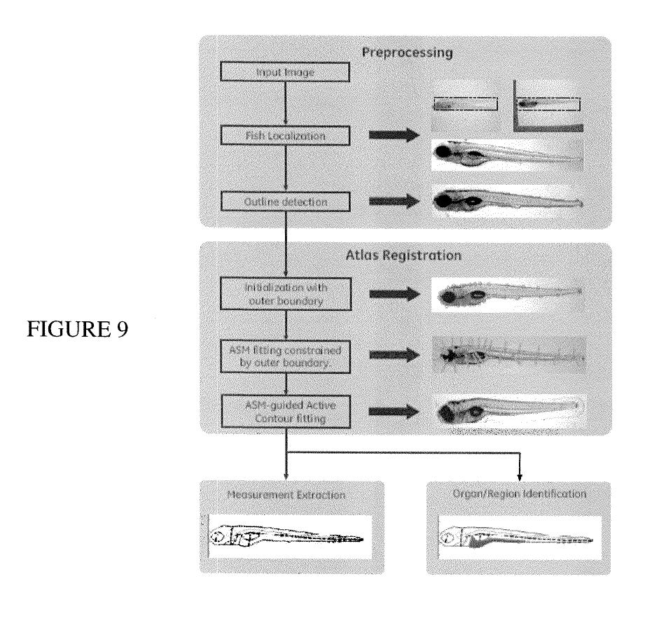

A general flow diagram is shown in FIG. 9 of an example of an atlas based measurement process. The process in this example begins with a digitized image of a zebrafish, preferably acquired with transmitted light imaging modality. During a preprocessing step, the foreground regions that belong to the fish are extracted, and key features, such as the head, eye and tail are detected and mapped.

Key features may be detected using an algorithm comprising, for example to detect a zebrafish eye, a multi-resolution Hough circle fitting algorithm with a binary search for optimal radius. Zebrafish whole-body segmentation may be achieved, but is not limited to, using an algorithm comprising quadtree decomposition of the image based on region variance and merging similar blocks.

After the preprocessing step and before the measurements are extracted, the atlas, an example of which is shown in FIG. 1, is then registered, or otherwise compared, to the mapped features of the sample organism and the segmentation boundaries are refined. Once registered, the system then measures and/or analyzes one or more of the regions, sub-regions, anatomical structures, features or characteristics of the sample in accordance with automatically predetermined, contemporaneously selected, or manually entered guidelines or instructions.

Automated atlas registration is used to fit the shape and key body regions of an organism, such as the zebrafish, to its digital atlas so that certain anatomical measurements can be automatically estimated or determined. The preprocessing step identifies one or more regions of interest in the organism. A global registration is applied to estimate the overall orientation and position of the organism in the image. Given the resulting region of interest, comprising one sample organism, the outline of the organism is identified using image segmentation. In one of the embodiments, a quad-tree method for image segmentation is applied to identify the outline of the sample.

An active shape model (ASM) algorithm may be employed to register the atlas to a sample. ASM comprises a shape model and an appearance model. Shape is represented using a set of pre-specified landmarks. ASM captures shape variations by training a principal component analysis (PCA) model from observed data. At each landmark, a local texture model is obtained by training a Gaussian model using the observed profile texture along the normal direction of the shape contour. Since organism shape can vary substantially from the norm, the outline of the organism is used to initialize the ASM algorithm at a solution very close to its global optima.

As shown in FIG. 9, ASM landmarks along fish contour are identified by optimizing the likelihood of the landmark segment length, curvature and image texture observations. The contour points may be considered as states and the sequential landmark assignment along the contour may be considered as a trajectory to be optimized. The global optimal assignment of the ASM landmarks may be obtained using a dynamic programming algorithm. After assignment of the outer ASM landmarks, the interior ASM landmarks are initialized by maximal likelihood estimation. In this example, since the statistics of fish outer boundary shape is correlated with the statistics of the fish interior shape structure, the maximal likelihood initialization of the fish interior shape are close to the ground truth. The ASM fitting algorithm is then used to maximize the likelihood of the texture observation of the fish interior fixing the ASM contour landmarks on the detected fish contour. Further refinement of the ASM fitting is achieved by Active Contours so that the shape and geometry can be fitted with higher accuracy. Finally the automatic fish measurements are carried out based on the registered atlas.

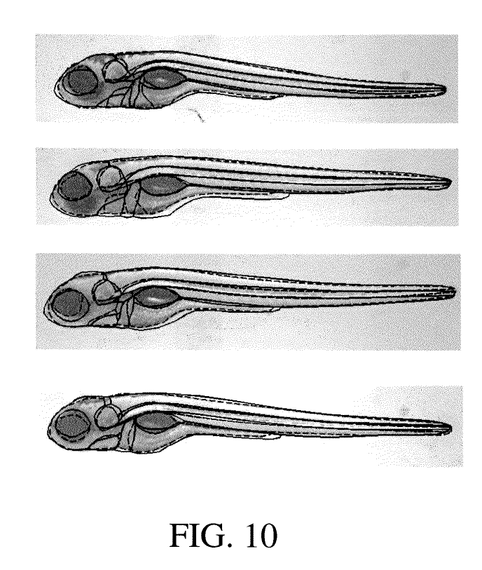

FIG. 10 shows examples of visual comparisons of the automatically fitted atlas (solid lines) and the atlas manually fitted by hand (dotted lines).

Measurements of a sample organism may be compared to a predetermined range of measurements to determine, for example, whether a given measurement falls outside of the normal range of measurements. High-throughput screening measurements may also, for example, be extracted for all organisms screened in a given run. Parameters such as, but not limited to, mean and variance, may be used to differentiate between normal, wild type, abnormal, and treated and untreated organisms, as well as toxicity and levels of toxicity. Measurements are not limited to geometrical measurements and may include, but are not limited to, variations in length, area, curvature, color, texture, shape, intensity and combinations thereof.

### EXAMPLE

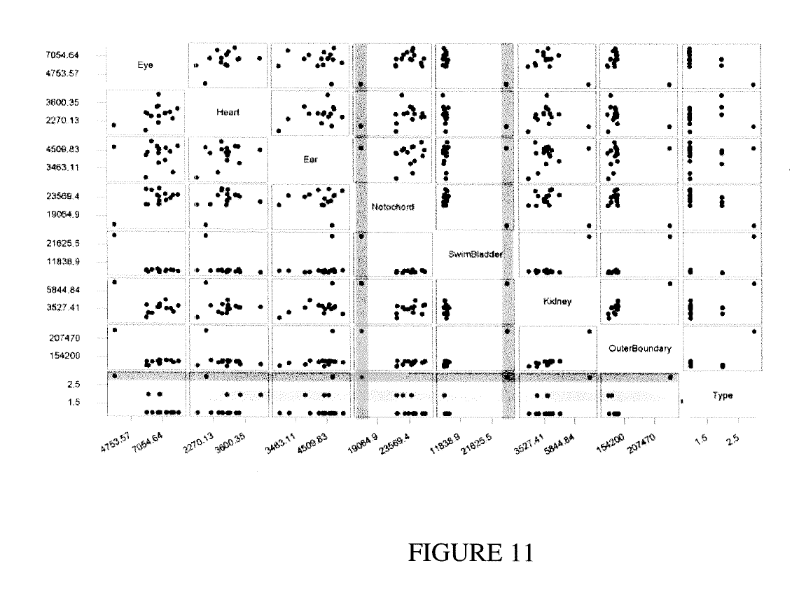

A dataset of measurements were automatically generated from eleven normal zebrafish, eight wild type zebrafish and one treated zebrafish after an atlas was fitted to the set of fish. FIG. 11 is a matrix plot of the area measurements.

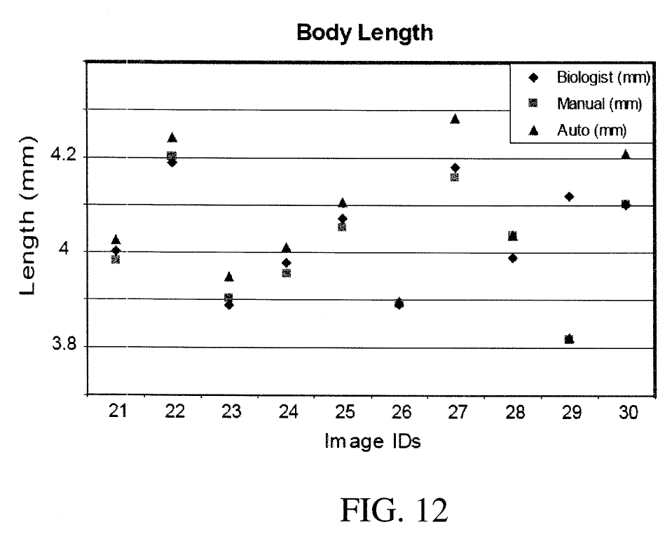

FIG. 12 is an example of a comparison of body length measurements in normal 120-hour zebrafish. As an example, body length is compared in manual and automated measurements. The diamonds represent manual measurements performed by a biologist; the triangles represent automated measurements; the squares represent measurements from manual fitting of the atlas.

The methods and systems may be configured to identify the developmental stage of an organism and to identify specific organs and sub-regions within the organs. Once identified, information about the organs and sub-regions may be further used to correlate the information according to an assay and/or an image of one or more fluorescent-based channel. An atlas of the organism is used in one or more of the embodiments to automatically locate the different organs in a zebrafish, for example, and then correlate the information to a predetermined set of rules or guidelines.

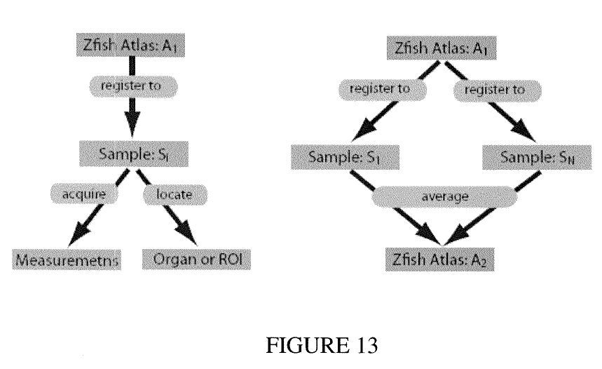

FIG. 13 illustrates non-limiting uses of the methods and systems. For example, the methods and systems may be used to determine anatomically relevant measurements, identify organs within the organism, and train an atlas for specific subpopulations. Measurements may include but are not limited to variations in length, area, curvature, color, grey-scale, intensity, texture, shape, fluorescence, and combinations thereof.

One or more of the embodiments of the methods and systems may comprise the steps and hardware for automatically acquiring one or more images of the sample organism. These automated imaging acquisition steps and the hardware needed for imaging the organism may be incorporated into automated, high-throughput screening systems such as an IN Cell Analyzer system available from GE Healthcare.

In a first step, a low-resolution image is taken of the sample organism to locate the position of the organism and to detect the specific location of one or more organs of interest within the organism. This information is then applied to automatically change the objective of the system and position a movable stage to take a high-resolution image of the organ of interest. An atlas is also used in one or more of the embodiments to correct or otherwise automatically enhance an image, for example, by image stitching.

The system may comprise an imaging device that is configured to automatically employ the atlas at lower resolution to determine the areas of interest and focus and image at higher resolution on the regions of the organism's body. In this way the imaging throughput may be significantly increased. As an example of application, if the organism such as the zebrafish is in the wells of a 96-well plate, one 5-day post fertilization fish per well, and one is interested to imaging the heart region (size about 200 micrometer (um)), a suitable resolution may be to image with a 10× objective magnification. Under this magnification, the area of the typical field of view of an automated high content imaging system, e.g. the IN Cell Analyzer from GE Healthcare, is about 0.6 mm². The circular well of a 96-well plate has a diameter of about 6.5 mm, or area of 33 mm². This implies that with the 10× objective at least 50 images must be acquired in each well until the heart area is imaged.

The operating device can be used to increase the speed of the system using, for example, the following steps: (1) acquisition of a single image of the whole well under 1× magnification; (2) online use of atlas analysis to locate the near exact value of the location of the heart area; (3) automated command of the motorized XY-stage movement to laterally move and center the heart area above the optical axis; (4) automated command of the motorized objective changer to change to a 10× objective; (5) automated command of the motorized Z-stage to axially move the objective to an appropriate level above the well bottom (e.g., 300 um, for better focusing); and/or (6) acquisition of transmitted and/or fluorescent images of the heart area. In some embodiments, all of the operations can be carried out simultaneously or nearly simultaneously, depending in part on whether multiple images are acquired. This example embodiment provides advantages such as, but not limited to, (a) high resolution imaging throughput can be increased significantly (at least 25 times in this example); (b) post processing of a large number of high resolution images is not necessary (e.g., analysis, stitching, flat field correction); and (c) system memory does not need to be hampered by the acquisition of a large number of useless images where most of the fields are empty.

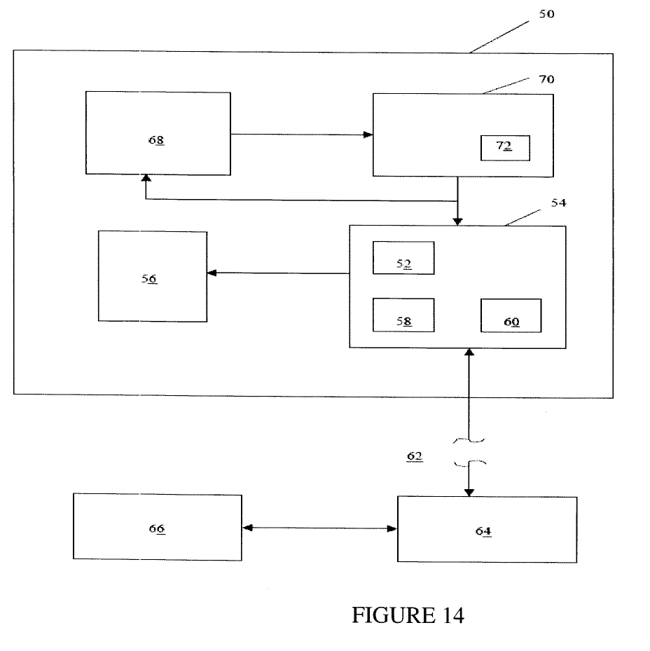

The automated system 50 (FIG. 14) generally comprises: a memory storage device 52 for at least temporarily storing the atlas of the organisms and storing images of the sample organisms; and an operating device 54, such as a processor, for carrying out one or more of the steps of the methods. The memory storage device may comprise any suitable hard drive memory associated with the processor such as the ROM (read only memory), RAM (random access memory) or DRAM (dynamic random access memory) of a CPU (central processing unit), or any suitable disk drive memory device such as a DVD or CD, or a zip drive or memory card or stick. The memory storage device may be remotely located from the processor or the display device for displaying the images, and yet still be accessed through any suitable connection device or communications network including but not limited to local area networks, cable networks, satellite networks, and the Internet, regardless whether hard wired or wireless. The processor or CPU may comprise a microprocessor, microcontroller and a digital signal processor (DSP).

The storage device 52 and the operating device 54 may be incorporated as components of an analytical device such as an automated high-speed system that images and analyzes in one system. Examples of such systems include, but are not limited to, the General Electric IN Cell Analyzer systems (General Electric Healthcare Bio-Sciences Group, Piscataway, N.J.). As noted, system 50 may further comprise a display device 56 for displaying one or more of the images of the sample organisms, the atlas, the atlas fitted on an image of the sample organism, measurement results and/or any other type of image, report or data useful for viewing by the user of the system; an interactive viewer 58; a virtual microscope 60; and/or a device for transmitting 62 one or more of the images or any related data or analytical information over a communications network 64 to one or more remote locations 66.

Display device 56 may comprise any suitable device capable of displaying a digital image such as, but not limited to, devices that incorporate an LCD or CRT. Transmitting device 62 may comprise any suitable means for transmitting digital information over a communications network including but not limited to hardwired or wireless digital communications systems. As in the IN Cell Analyzer, the system may further comprise an automated device 68 for processing assays or otherwise applying stains, markers, probes or other similar research tools; and a digital imaging device 70 such as, but not limited to, a fluorescent imaging microscope comprising an excitation source 72 and capable of capturing digital images of the sample organisms of interest. Such imaging devices may have a movable stage and may be capable of auto focusing and then maintaining and tracking the focus feature as needed.

The methods and systems may be used for a wide variety of application including, but not limited to,

### Organ Specific Toxicity

Neurotoxicity

Cardiotoxicity

Liver toxicity

Kidney toxicity

Gastrointestinal toxicity

Pancreatic toxicity

### Neural Assays

### Angiogenesis Assays

### Apoptosis Assays

High content screening of chemical libraries
Cardiac function assessment
Genotype studies

### General Toxicity

### Specific Toxicity

### Genetic Toxicity

### Pathology

### Cellular Assays:

Flow Cytometry

Cell Cycle

### Gene Expression

### HTS of Chemical Libraries

Angiogenesis

Apoptosis

### Target Validation

### Tumor Cell Transplantation

While only certain features of the invention have been illustrated and described herein, many modifications and changes will occur to those skilled in the art. It is, therefore, to be understood that the appended claims are intended to cover all such modifications and changes as fall within the true spirit of the invention.

1. An system for screening zebrafish comprising:
a storage device for at least temporarily storing an image of a zebrafish to be screened;
a zebrafish atlas; and
an operating device that automatically screens the zebrafish at least in part by automatically comparing one or more anatomical features of the zebrafish, determined at least in part using the zebrafish atlas, to one or more standards.

2. The system of claim 1, wherein one or more of the anatomical features of the zebrafish comprise measurements of the zebrafish, body, notochord, tail, trunk, eye, head, abdomen, swim bladder, jaw, heart, gastro-intestinal tract, or liver.

3. The system of claim 1, wherein one or more of the anatomical features of the zebrafish comprise spots, brain color, brain texture, tail shape, somite shape, eye pigmentation, cardiac change, body pigmentation, straightness of the notochord, fin shape, intestine shape, intestine color, existence of axons, or cell or tissue necrosis.

4. The system of claim 1, wherein the operating device determines a developmental stage of the zebrafish.

5. The system of claim 1, wherein one or more of the standards is a control fish.

6. The system of claim 1, wherein the operating device identifies a strain to which the zebrafish corresponds.

7. The system of claim 6, wherein the strain is identified at least in part by comparing the zebrafish to a library of candidate zebrafish strains accessible to the operating system.

8. The system of claim 7, wherein the strain is identified by comparing one or more of the anatomical features to one or more of the candidate zebrafish strains in the library.

9. The system of claim 1, wherein the anatomical features comprise one or more measurements of the zebrafish, and wherein the operating device screens the zebrafish for toxicity at least in part by comparing one or more of the measurements to a toxicity standard.

10. The system of claim 9, wherein the measurements comprise one or more of length, area, curvature, color, texture, shape, intensity and combinations thereof.

11. The system of claim 1, wherein the operating device screens the zebrafish for toxicity at least in part by automatically identifying one or more developmental defects in the zebrafish.

12. The system of claim 1, further comprises an imaging device.

13. The system of claim 12, wherein the imaging device takes a plurality of images of the zebrafish at various levels of resolution.

14. The system of claim 13, wherein one of the images is a lower resolution image of the entire zebrafish and one of the images is a higher resolution image of one or more organs within the zebrafish.

15. The system of claim 13, wherein the operating system applies real-time atlas analysis to one or more low resolution images, to initiate acquisition of one or more high resolution images, at least in part by identifying the organ and centering the organ in a high magnification field of view.

16. The system of claim 1, wherein the storage device further stores information on one or more agents, and wherein the operating device gathers data relating to one or more organs within the zebrafish and correlates the data with the information on one or more agents.

17. The system of claim 16, wherein the operating device determines one or more levels of toxicity based on the correlation of the organ data to the agent information.

18. The system of claim 1, wherein the atlas is adaptable.

19. A method for screening zebrafish comprising:
providing an image of a zebrafish to be screened;
providing a zebrafish atlas and automatically measuring one or more anatomical features of the zebrafish at least in part using the atlas; and
screening the zebrafish at least in part by automatically comparing one or more of the anatomical features of the zebrafish to one or more standards.

20. The method of claim 19, wherein the measurements comprise one or more of length, area, curvature, color, texture, shape, intensity and combinations thereof.

21. The method of claim 20, wherein the one or more of the standards correspond to one or more of length, area, curvature, color, texture, shape, intensity and combinations thereof.

22. The method of claim 19, wherein one or more of the anatomical features of the zebrafish comprise measurements of the zebrafish body, notochord, tail, trunk, eye, head, abdomen, swim bladder, jaw, heart, gastrointestinal tract, or liver.

23. The method of claim 19, wherein one or more of the anatomical features of the zebrafish comprise spots, brain color, brain texture, tail shape, somite shape, cardiac change, eye pigmentation, body pigmentation, straightness of the notochord, fin shape, intestine shape, intestine color, existence of axons, or cell or tissue necrosis.

24. The method of claim 19, further comprising automatically determining a developmental stage of the zebrafish.

25. The method of claim 19, wherein one or more of the standards comprises a control fish, a previous image of the zebrafish, a library-based standard, or an amalgamation of a plurality of fish.

26. The method of claim 19, wherein the amalgamation comprises a computed statistic of one or more features of the plurality of fish that correspond to the anatomical features of the zebrafish.

27. The method of claim 19, further comprising identifying a strain to which the zebrafish corresponds wherein the strain is identified at least in part by automatically comparing the zebrafish to a library of candidate zebrafish strains accessible to the operating system.

28. The method of claim 19, wherein toxicity is screened at least in part by automatically identifying one or more developmental defects in the zebrafish.

29. The method of claim 19, further comprising, determining one or more levels of toxicity in one or more organs of the zebrafish.

30. The method of claim 19, further comprising determining a phenotype of the zebrafish.

31. The method of claim 19, further comprising determining a genotype of the zebrafish.
